(19) United States
(12) Patent Application Publication
(10) Pub. No.: US 2010/0156624 A1
(43) Pub. Date: Jun. 24, 2010

(54) RADIO PROXIMITY MONITORING

(76) Inventor: Ben Hounsell, Edinburgh (GB)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/523,531

(22) PCT Filed: Jan. 17, 2008
(86) PCT No.: PCT/GB08/00148

§ 371 Date: Jan. 21, 2010

(30) Foreign Application Priority Data
Jan. 17, 2007 (GB) 0700875.8

(51) Int. Cl. G08B 1/08; H04B 7/00

(52) U.S. Cl. 340/539.1; 455/41.2

(57) ABSTRACT

A tag (2) is attachable to items such as a briefcase or a laptop and communicates via Bluetooth™ (4,8) with a mobile (cell) phone (6). In use, a user carries their mobile phone on their person and the proximity of one or more of the tags is monitored (14). When a tag goes out of range then alarms (18,20) are triggered (16). The transmitter device (tag or phone) transmits radio signals with a plurality of set transmission powers (5), each corresponding to a respective set proximity, with Bluetooth power adaption turned off. The proximity is monitored by using a correlation between RSSI signal strength (10) and BER link quality (12) measurements. The proximity may be monitored by using a delay count measurement, including a measure of the time to successfully transfer data to a buffer (9). The signal strength (26), link quality (28) and delay count (30) measurements are combined into a confidence measure (32) to monitor proximity.

The present invention relates to apparatus for monitoring proximity using radio signals, in particular apparatus using signal strength and link quality of radio signals such as Bluetooth®.

Businesses are becoming increasingly reliant on mobile employees to exploit new business opportunities. Laptops, briefcases and other important items are required to offer true business mobility. However this mobility presents risks, as losing these items can have serious consequences for a business.

In order to prevent a user from losing such items, the proximity of the item and the user can be monitored using radio devices. For example two Bluetooth devices can be mounted one each on the user and the item to be monitored. The proximity of the Bluetooth devices can be monitored by transmitting Bluetooth radio signals from one device to the other and using the signals to measure the distance between the devices, or whether the devices are within a set range or zone.

Typically such schemes using Bluetooth technology are based on the Received Signal Strength Indication (RSSI) of the radio signal. The signal strength is used simply as an indication of the distance. The weaker the signal the greater the separation between the two Bluetooth devices. This approach works well in free space but is less reliable in a confined environment, with many obstacles interfering with the radio signals.

Alternatives to using RSSI for Bluetooth proximity detection include measuring link quality. As the distance increases between the Bluetooth devices the link quality degrades. The lower link quality is apparent as increased bit error rate and thus the number of packet retransmissions. Packet loss rate can be measured directly or indirectly, for example by measuring the service discovery time using the round trip time of the Bluetooth Service Discovery Protocol (SDP) packets as disclosed in “Farther than you may think: an empirical investigation of the proximity of users to their mobile phones”, Patel et al, UBIComp 2006. Link quality measurements for distance estimation may also be obtained using the Bluetooth HCI Read Link Quality command as disclosed in “Algorithms and protocols enhancing mobility support for wireless sensor networks based on Bluetooth and Zigbee”, Chapter 3, Javier García Castańo, PhD thesis Mälardalen University, Sweden, 2006.

In the presence of obstacles interfering with the radio signals between the Bluetooth devices both RSSI and link quality become less reliable as a measure of proximity. Therefore Bluetooth has not been used to address the loss or theft of personal items and important confidential information. This is a lost opportunity because many users now carry Bluetooth enabled devices in the form of mobile phones and personal digital assistants (PDAs) with them at all times. Existing radio proximity detection solutions require the use of a transmitter which must be carried by the user in addition to their other portable devices. It would be unrealistic and costly to add specific radio proximity detection hardware to mobile phones.

It is an object of the present invention to provide improved monitoring of proximity.

According to a first aspect of the present invention there is provided an apparatus for monitoring proximity comprising:
a transmitter device operable to transmit electromagnetic signals;
a receiver device operable to receive the electromagnetic signals so as to establish a link between the devices; and
a proximity monitoring module operable to monitor the proximity of the transmitter device and the receiver device using the electromagnetic signals,
   wherein the transmitter device is configurably operable to transmit electromagnetic signals with a plurality of transmission powers each corresponding to a respective set proximity.

Preferably, the electromagnetic signals comprise radio signals.

Preferably, the transmitter device is operable with power adaptation and is operable to transmit the electromagnetic signals with the power adaptation disabled.

Preferably, the electromagnetic signals comprise Bluetooth protocol radio signals.

Preferably, the apparatus further comprises at least one alarm and a trigger module operable to trigger at least one alarm conditional on the monitored proximity.

Preferably, the transmitter device comprises at least one of the alarms.

Preferably, the receiver device comprises at least one of the alarms.

Preferably, the transmitter device is configured to be attachable to an item.

Preferably, the apparatus further comprises a signal strength module operable to determine a signal strength of the received electromagnetic signals and the proximity monitoring module is further operable to monitor the proximity of the transmitter device and the receiver device using the signal strength.

Preferably, the signal strength comprises a Received Signal Strength Indication.

Preferably, the apparatus further comprises a link quality module operable to determine a link quality of the established link and the proximity monitoring module is further operable to monitor the proximity of the transmitter device and the receiver device using the link quality.

Preferably, the link quality comprises a Bit Error Rate.

Preferably, the proximity monitoring module is further operable to monitor the proximity of the transmitter device and the receiver device using a correlation between the signal strength and the link quality.

Preferably, the signal strength module is configurable to control an indicator directly responsive to the signal strength, so as to locate the transmitter device.

Preferably, the indicator comprises at least one of the alarms.

Preferably, the apparatus further comprises a further link quality module operable to determine a further link quality of the established link, and the proximity monitoring module is further operable to monitor the proximity of the transmitter device and the receiver device using the further link quality.

Preferably, the proximity monitoring module is further operable to monitor the proximity of the transmitter device and the receiver device using a correlation between two or more of the signal strength, the link quality and the further link quality.

Preferably, the further link quality comprises a delay count measurement.

Preferably, the delay count measurement comprises a measure of the time taken for the transmitter device and the receiver device to successfully pass data.

Preferably, the trigger module is further operable to trigger at least one alarm when a set time to successfully pass data has been exceeded.

Preferably, the apparatus further comprises a buffer operable to store one or more packets of the link and the delay count measurement comprises a measure of the time to fill the buffer.

Preferably, the proximity monitor module is operable to monitor the proximity by a combination of the signal strength and link quality into a confidence measure.

Preferably, the combination comprises calculating a probability density function.

Preferably, the combination uses adaptive weighting of at least one of the signal strength and the link quality.

Preferably, the adaptive weighting uses thresholds that vary as a function of proximity.

Preferably, the combination comprises multiplying the signal strength and the link quality together.

Preferably, the proximity monitor module is operable to monitor the proximity by a combination of two or more of the signal strength, the link quality and the further link quality into a confidence measure.

Preferably, the combination comprises calculating a probability density function.

Preferably, the combination uses adaptive weighting of at least one of the signal strength, the link quality and the further link quality.

Preferably, the adaptive weighting uses thresholds that vary as a function of proximity.

Preferably, the trigger module is further operable to trigger at least one alarm based on a calendar.

Preferably, the trigger module is further operable to trigger at least one alarm when the monitored proximity corresponds to a set distance.

Preferably, the set distance is user configurable.

Preferably, the apparatus further comprises a logger operable to log in a database the triggering of at least one alarm.

Preferably, the logger records the time and date of the triggering.

Preferably, the logger records an identifier of the transmitter device.

Preferably, the logger records user details.

Preferably, the logger records a location associated with the triggering.

According to a second aspect of the present invention there is provided apparatus for monitoring proximity comprising:
a transmitter device operable to transmit electromagnetic signals;
a receiver device operable to receive the electromagnetic signals so as to establish a link between the devices;
a signal strength module operable to determine a signal strength of the received electromagnetic signals;
a link quality module operable to determine a link quality of the established link; and
a proximity monitoring module operable to monitor the proximity of the transmitter device and the receiver device using a correlation between the signal strength and the link quality.

Preferably, the transmitter device is further configurably operable to transmit the electromagnetic signals with a plurality of transmission powers each corresponding to a respective set proximity.

Preferably, the apparatus further comprises a further link quality module operable to determine a further link quality of the established link, and the proximity monitoring module is further operable to monitor the proximity of the transmitter device and the receiver device using the further link quality.

Preferably, the further link quality comprises a delay count measurement.

Further embodiments of the second aspect may comprise one or more features of the first aspect.

According to a third aspect of the present invention there is provided apparatus for monitoring proximity comprising:
a transmitter device operable to transmit electromagnetic signals;
a receiver device operable to receive the electromagnetic signals so as to establish a link between the devices; and
a proximity monitoring module operable to monitor the proximity of the transmitter device and the receiver device using a delay count measurement.

Preferably, the transmitter device is further configurably operable to transmit the electromagnetic signals with a plurality of transmission powers each corresponding to a respective set proximity.

Preferably, the apparatus further comprises a signal strength module operable to determine a signal strength of the received electromagnetic signals and the proximity monitoring module is further operable to monitor the proximity of the transmitter device and the receiver device using the signal strength.

Preferably, the apparatus further comprises a link quality module operable to determine a link quality of the established link and the proximity monitoring module is further operable to monitor the proximity of the transmitter device and the receiver device using the link quality.

Preferably, the proximity monitoring module is further operable to monitor the proximity of the transmitter device and the receiver device using a correlation between the signal strength and the link quality.

Further embodiments of the third aspect may comprise one or more features of the first aspect.

The present invention will now be described by way of example only with reference to the drawings, in which:

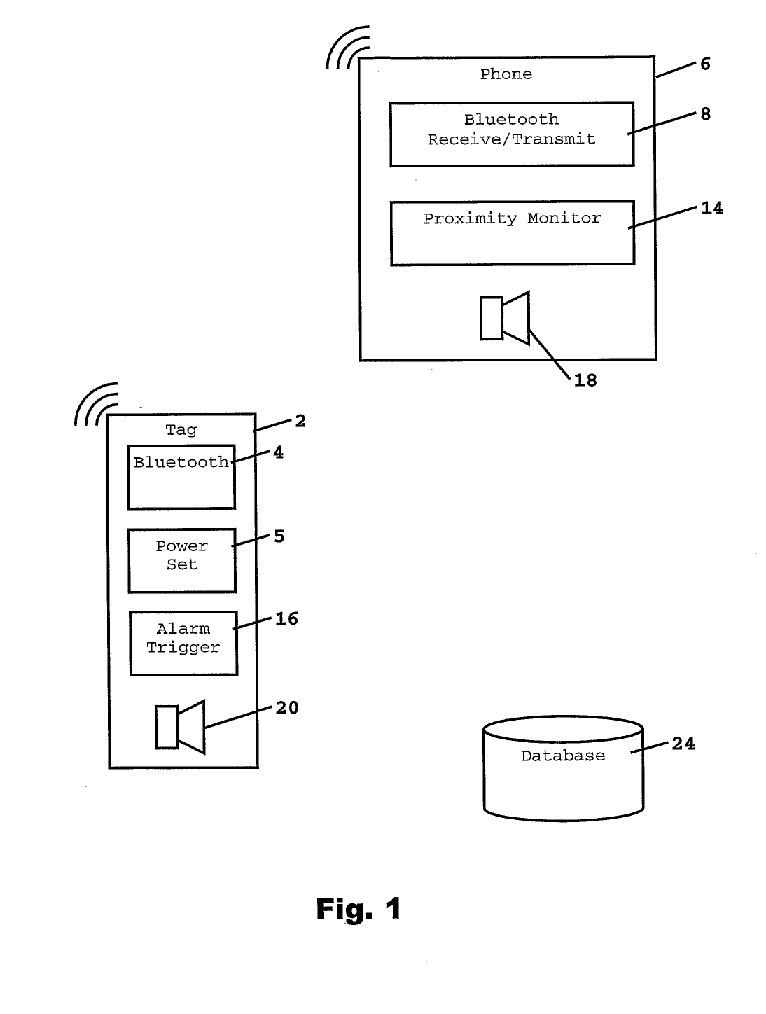

FIG. 1 illustrates, in schematic form, the apparatus according to a first embodiment of the present invention;

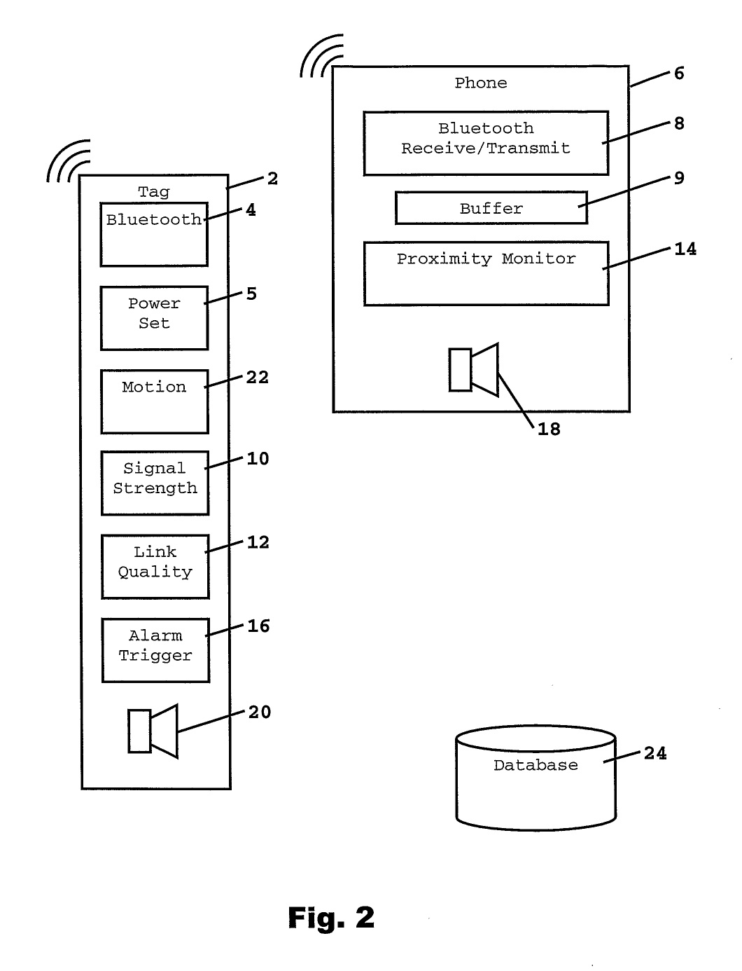

FIG. 2 illustrates, in schematic form, the apparatus according to a second embodiment of the present invention; and

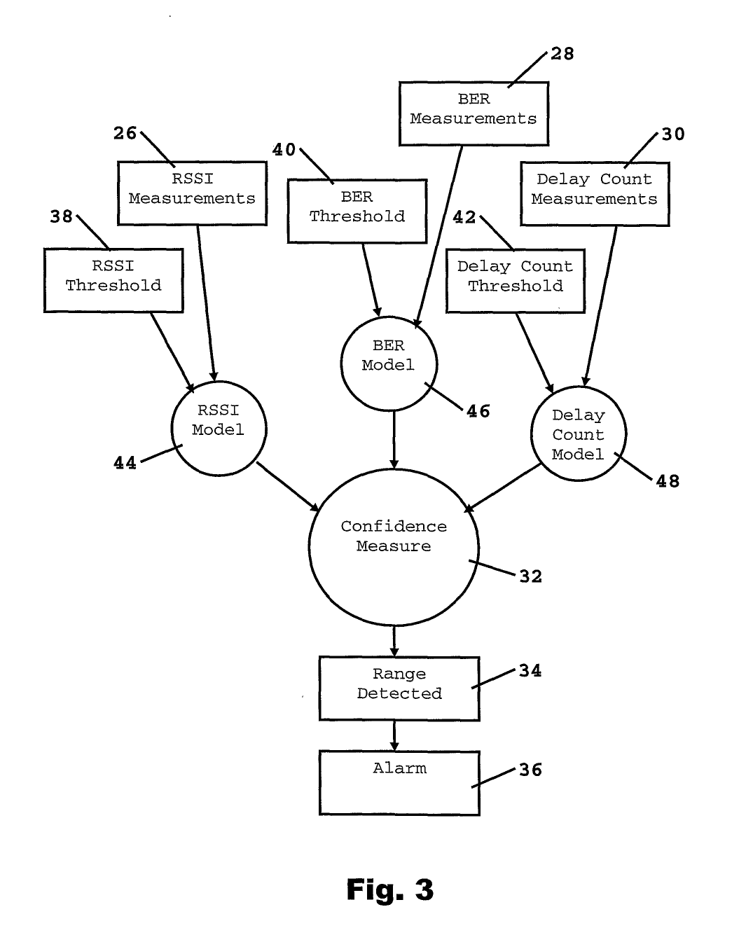

FIG. 3 illustrates, in schematic form, the process of monitoring proximity in accordance with the present invention.

Embodiments of the present invention have a tag that is attachable to items such as a briefcase or a laptop and that communicates via Bluetooth with a mobile phone. A user carries their mobile phone on their person and the proximity of one or more of the tags is monitored. When a tag goes out of range an alarm sounds. Either one or both of the tag and the mobile phone may have the alarm. Although Bluetooth is used, any other electromagnetic signal or radio transmission protocol could be used.

With reference to FIG. 1, a tag 2 has a Bluetooth transceiver 4 and a power setting module 5. In this embodiment the tag is the transmitter device, which is operable to transmit radio signals with a set, fixed power.

Improved proximity monitoring is achieved by restricting the power transmitted from the transmitter device in a way that it corresponds to a predetermined maximum distance to be detected during proximity monitoring. When this distance is reached and the power transmitted becomes insufficient to keep a good connection, the connection is dropped and an alarm triggered. Therefore a higher restricted transmission power is set for longer distances. This technique, similar to that used by Bluetooth to set devices in three different classes (class 1 to class 3), can be used on its own to set a distance for monitoring, but it is also useful when combined with the other techniques described below. In an embodiment of the present invention the tag's transmit power is set by the power setting module to its maximum output in order to be able to initially connect to the mobile phone. Once the connection is established, the transmit power on the tag is configured to that desired by the user, for example by the user selecting a high or a low level of security corresponding to a low power (near proximity) or high power (far proximity) respectively. This set power may be lower than the maximum possible transmit power.

Bluetooth has a power adaptation scheme to increase the transmitted power of a Bluetooth device when the link quality is deemed poor. The transmitted power is similarly reduced when the link quality is deemed to be good. The power setting module of this embodiment fixes the power during proximity monitoring by disabling the Bluetooth power adaptation function. By disabling the power adaptation, the RSSI, BER and delay count readings discussed below are not adversely affected by this power control scheme of Bluetooth. This is not something that is normally done as it would be an inconvenience to most applications. However it is advantageous when monitoring the proximity between two Bluetooth devices.

Disabling the power adaptation can be achieved with a low-level function call in the Bluetooth enabled tag. This has the advantage that low-level access to the Bluetooth functionality of the mobile phone is not needed. Such access would normally be hidden from applications running on the phone. This means that the apparatus of the present invention can be implemented using standard mobile phones running high-level applications. Disabling the power adaptation on the tag causes the power adaptation on the phone to be disabled for the Bluetooth communication with the tag. However, Bluetooth communication by the phone with other Bluetooth devices, such as headsets, may carry on with power adaptation working as normal. This is an advantage of disabling the power adaptation on the tag, rather than on the phone.

In this embodiment a mobile phone 8 or PDA (Personal Digital Assistant) has a Bluetooth transceiver 8. The phone is operable to receive the radio signals from the transmitter device.

A proximity monitor module 14 is operable to monitor the proximity of the tag and the phone using the radio signals. The monitored proximity is communicated via the Bluetooth link to the tag. A trigger module 16 in the tag is operable to trigger at least one of the alarms in the phone 18, in the tag 20, or elsewhere. The triggering is conditional on the monitored proximity. An advantage of the trigger module being in the tag is that the tag can self alarm if the Bluetooth connection is lost before the proximity monitor module has time to communicate out-of-range proximity data to the alarm trigger module. A database 24 is used to log the alarm trigger events.

With reference to FIG. 2, a second embodiment of the present invention is shown. In this embodiment, the signal strength and link quality of the Bluetooth connection are used to determine the proximity of the tag to the receiver. The elements, including the power setting, are as described with reference to FIG. 1. A data buffer 9 in the phone is used to store received packets. A signal strength module 10 in the tag is operable to determine the signal strength of the received radio signals. A link quality module 12 in the tag is operable to determine the quality of the link established by the radio signals. The Bluetooth link is used to transfer the determined signal strength and link quality to the phone. A proximity monitor module 14 in the phone is operable to monitor the proximity of the tag and the phone using the correlation between the signal strength and the link quality. The tag also has a motion sensor 22.

In another mode of operation of each embodiment, so as to locate the tag, the signal strength module is configurable to control an indicator, such as sounding the alarm in the phone, directly responsive to the signal strength. When using the RSSI on its own the readings are more susceptible to orientation. Therefore stronger RSSI readings are obtained when facing the tag and/or getting closer to it. This may be used to control the sound of the alarm to precisely locate a lost or misplaced object. For example, the alarm may be controlled to beep faster as the RSSI measurements increase.

Although in both embodiments the transmitter for the RSSI is in the tag and the receiver for the RSSI measurements is in the phone, other embodiments may have the components of the apparatus distributed differently. For example, the bulk of the processing of the proximity monitoring could be done by the tag, or the proximity monitoring could be split between the phone and the tag, or done elsewhere, such as on a server. Furthermore, for example, the signal strength and/or link quality modules could be in the phone, as could the alarm trigger module. Furthermore, the proximity could be monitored using radio signals from the phone to the tag, or in both directions. Also, for example, round trip communications may be used for determining the link quality.

The second embodiment of the present invention uses Bit Error Rate (BER) with the Received Signal Strength Indication (RSSI) of Bluetooth communication and a delay count to monitor the proximity of the two Bluetooth devices. A correlation between two or more of these measurements may be used to monitor the proximity.

The BER, which is a measure of the quality of the link, and the RSSI both degrade with the distance separating the transmitter from the receiver. Furthermore, a delay count mechanism provides extra confidence when monitoring whether the device is moved beyond the set distance. This delay count mechanism is based on a measure of the number of clock cycles it takes the receiving Bluetooth device to fill its data buffer (9 in FIG. 1). This has a direct relationship to the distance separating the two devices. Generally the greater the distance between two Bluetooth devices the more packets are dropped by the receiver as a result of signal degradation and corruption. The receiver must then ask for the data to be resent (a feature which is mandatory in a Bluetooth Asynchronous ConnectionLess connection), which in turn increases the time taken for the two devices to successfully pass data, thereby increasing the delay count. Accordingly, the buffer may be one packet or unit of data in size. If no data reaches the buffer in a given set time (e.g. when the connection is lost altogether because of increased distance), then an alarm will be triggered at one or both ends of the link, as the time taken to successfully pass data (and optionally to acknowledge it to the other end) has exceeded the set limit.

With reference to FIG. 3, RSSI measurements 26, BER measurements 28 and delay count measurements 30 are combined into one confidence measure 32 to monitor whether a specific distance between the devices has been reached. When the out-of-range condition has been detected 34 an alarm is triggered 36. An adaptive weighting using an RSSI threshold 38, BER threshold 40 and delay count threshold 42 applied to an RSSI model 44, a BER model 46 and a delay count model 48 respectively is used to calculate the probability density function (PDF) of the alarm being triggered if the set range is exceeded. The weighting depends on where within the range the thresholds are set and how confident the system is of the correctness of the readings. The RSSI and the BER versus time distributions show good similarities and symmetry when a true alarm should be triggered. They respond slightly differently or with small delays to false alarms. The proximity monitoring module extracts the relevant features from the distributions by multiplying them together. Similar peaks in the distributions are emphasised while entire regions are vetoed when the distributions are in contradiction. This approach gives rise to more robust predictions since all distributions need concurrent peaks at the same regions for the confidence measure to give a high probability. If one of the models does not validate the same regions as the other, it vetoes it and therefore decreases the likelihood that the alarm is triggered. When the models concur a sharp surge indicates with confidence that the alarm should be triggered.

Another benefit of the feature extraction approach is that it is possible to predict from the RSSI and BER measurements the impact of link quality depending on the environment the devices are in. This embodiment of the present invention can therefore automatically adjust its algorithm parameters accordingly. When it is judged that the environment is poor the connection can enter a high security mode, by setting the power to a lower value. Inversely, if the environment is deemed good (with good vision of the devices) then a lower security mode can be used. By doing so the overall accuracy of the system is improved. As shown in FIG. 3 the RSSI measurements and the RSSI threshold calibrated at the desired range both contribute to the making of the RSSI model. The same is true with the BER and delay count measurements and thresholds. The three models are then combined to give an overall probability of the set distance being exceeded by extracting simultaneous peaks on the three models.

Each time an alarm is sounded as a result of the tag moving too far away from the phone or the motion sensor on the tag being tripped, the event is sent to a central database where the time and date of the event is logged and the user details (such as a name) and a tag ID is stored. For phones or PDAs with GPS (Global Positioning System) functionality, location coordinates of where the alarm took place are also recorded and sent to the database. The data sent from the mobile device to the database can be transmitted by any medium available on a mobile device such as but not limited to text, 3G (third generation) or GPRS (general packet radio service).

Further modifications and improvements may be added without departing from the scope of the invention described by the claims herein.

What is claimed is:

1. An apparatus for monitoring proximity comprising:
a transmitter device operable to transmit electromagnetic signals;
a receiver device operable to receive the electromagnetic signals so as to establish a link between the devices; and
a proximity monitoring module operable to monitor the proximity of the transmitter device and the receiver device using the electromagnetic signals,
wherein the transmitter device is configurably operable to transmit electromagnetic signals with a plurality of transmission powers each corresponding to a respective set proximity.

2. The apparatus of claim 1 wherein the electromagnetic signals comprise radio signals.

3. The apparatus of claim 1 wherein the transmitter device is operable with power adaptation and is operable to transmit the electromagnetic signals with the power adaptation disabled.

4. The apparatus of claim 1 wherein the electromagnetic signals comprise Bluetooth protocol radio signals.

5. The apparatus of claim 1 further comprising at least one alarm and a trigger module operable to trigger at least one alarm conditional on the monitored proximity.

6. The apparatus of claim 5 wherein the transmitter device comprises at least one of the alarms.

7. The apparatus of claim 5 wherein the receiver device comprises at least one of the alarms.

8. The apparatus of claim 1 wherein the transmitter device is configured to be attachable to an item.

9. The apparatus of claim 1 further comprising a signal strength module operable to determine a signal strength of the received electromagnetic signals and the proximity monitoring module is further operable to monitor the proximity of the transmitter device and the receiver device using the signal strength.

10. The apparatus of claim 9 wherein the signal strength comprises a Received Signal Strength Indication.

11. The apparatus of claim 1 further comprising a link quality module operable to determine a link quality of the established link and the proximity monitoring module is further operable to monitor the proximity of the transmitter device and the receiver device using the link quality.

12. The apparatus of claim 11 wherein the link quality comprises a Bit Error Rate.

13. The apparatus of claim 11 wherein the proximity monitoring module is further operable to monitor the proximity of the transmitter device and the receiver device using a correlation between the signal strength and the link quality.

14. The apparatus of claim 9 wherein the signal strength module is configurable to control an indicator directly responsive to the signal strength, so as to locate the transmitter device.

15. The apparatus of claim 14 wherein the indicator comprises at least one of the alarms.

16. The apparatus of claim 1 further comprising a further link quality module operable to determine a further link quality of the established link, and the proximity monitoring module is further operable to monitor the proximity of the transmitter device and the receiver device using the further link quality.

17. The apparatus of claim 16 wherein the proximity monitoring module is further operable to monitor the proximity of the transmitter device and the receiver device using a correlation between two or more of the signal strength, the link quality and the further link quality.

18. The apparatus of claim 16 wherein the further link quality comprises a delay count measurement.

19. The apparatus of claim 18 wherein the delay count measurement comprises a measure of the time taken for the transmitter device and the receiver device to successfully pass data.

20. The apparatus of claim 19 wherein the trigger module is further operable to trigger at least one alarm when a set time to successfully pass data has been exceeded.

21. The apparatus of claim 18 wherein the apparatus further comprises a buffer operable to store one or more packets of the link and the delay count measurement comprises a measure of the time to fill the buffer.

22. The apparatus of claim 11 wherein the proximity monitor module is operable to monitor the proximity by a combination of the signal strength and link quality into a confidence measure.

23. The apparatus of claim 22 wherein the combination comprises calculating a probability density function.

24. The apparatus of claim 22 wherein the combination uses adaptive weighting of at least one of the signal strength and the link quality.

25. The apparatus of claim 24 wherein the adaptive weighting uses thresholds that vary as a function of proximity.

26. The apparatus of claim 22 wherein the combination comprises multiplying the signal strength and the link quality together.

27. The apparatus of claim 16 wherein the proximity monitor module is operable to monitor the proximity by a combination of two or more of the signal strength, the link quality and the further link quality into a confidence measure.

28. The apparatus of claim 27 wherein the combination comprises calculating a probability density function.

29. The apparatus of claim 27 wherein the combination uses adaptive weighting of at least one of the signal strength, the link quality and the further link quality.

30. The apparatus of claim 29 wherein the adaptive weighting uses thresholds that vary as a function of proximity.

31. The apparatus of claim 5 wherein the trigger module is further operable to trigger at least one alarm based on a calendar.

32. The apparatus of claim 5 wherein the trigger module is further operable to trigger at least one alarm when the monitored proximity corresponds to a set distance.

33. The apparatus of claim 32 wherein the set distance is user configurable.

34. The apparatus of claim 5 wherein the apparatus further comprises a logger operable to log in a database the triggering of at least one alarm.

35. The apparatus of claim 34 wherein the logger records the time and date of the triggering.

36. The apparatus of claim 34 wherein the logger records an identifier of the transmitter device.

37. The apparatus of claim 34 wherein the logger records user details.

38. The apparatus of claim 34 wherein the logger records a location associated with the triggering.
